(19) United States
(12) Patent Application Publication
(10) Pub. No.: US 2019/0031113 A1
(43) Pub. Date: Jan. 31, 2019

(54) Handsfree Smartphone Stand for Mounting behind the Steering Wheel

(71) Applicant: Renato Munoz, San Jose (CR)

(72) Inventor: Renato Munoz, San Jose (CR)

(21) Appl. No.: 15/935,031

(22) Filed: Mar. 25, 2018

(30) Foreign Application Priority Data
Jul. 26, 2017 (CR) 2017-0000342

(51) Int. Cl. B60R 11/02

(52) U.S. Cl. CPC B60R 11/0241; B60R 2011/001

(57) ABSTRACT

The handsfree smartphone stand for mounting behind the steering wheel consists of a strap and a clasp/holder with angles, mechanisms and dimensions that hold the phone firmly in the space shown in Drawing 1 (19). This placement allows the driver to operate the telephone while keeping both hands on the wheel without presenting an obstacle during normal operation. The position also prevents the device from contacting the compartment where the air bag is situated inside the steering wheel (28) and the lights and windshield wiper levers. The stand's design permits the use of the phone without causing unwanted movements that will prevent from exerting the necessary pressure to activate the telephone's commands. The device can have a battery to charge the telephone.

### BACKGROUND OF THE INVENTION

In the field of smartphone car stands there are currently devices that place the telephone in front of, or aligned with the steering wheel, displaying the following performances:
The rubber band or mechanism used to attach to steering wheel isn't sufficiently strong to hold the telephone firmly and makes it slide back when operating the front commands. This movement might prevent activating the telephone if a certain amount of pressure is required.
The telephone is in alignment with the steering wheel, creating a problem in cars with smaller steering wheels, and with larger telephones. In these cases, the phone may interfere with the airbag placed in the center of steering wheel.
When the stand allows the driver to place the telephone vertically, not only there is interference with the airbag compartment, but also forces the driver to let go one hand of the steering wheel to access the home button placed on the bottom of most cell phones.

### BRIEF DESCRIPTION OF THE INVENTION

The handsfree smartphone stand for mounting behind the steering wheel (19) has two main components:
A strap (1) that attaches, pressing against the steering wheel with a screw (3) placed in the back of the device. This strap has two pieces (7 & 8) that come apart to place over the steering wheel and are joined with an edge (6) and aligning opening (24) with the mentioned screw (3).
The second component is a supporting box (2) with two fasteners at the ends (4 & 5) which hold the telephone in place through an opening mechanism (10 & 16). The fasteners have an internal vacuum covered by fixed pieces of rubber (11) and an edge that keeps the phone from falling off (13).

The design of the two sections offers improvements in the technique used in positioning of the telephone (19); in its handling, and in the steadiness with which it is held. First, the device is placed horizontally, in a point behind the steering wheel (19), where it is possible to operate without having to take the hands off the steering wheel. On the other hand, the firmness of the strap attached to the steering wheel (1) and the strength of the fastener holding the telephone (21), allow the operation of any button on the telephone without creating movement that impedes operation. Placement behind the wheel (19) not only separates both the telephone and the holder from the compartment that stores the air bag; but prevents interference to the lights and wiper levers. Hands can slide without a problem along the steering wheel (20) without the telephone hitting them during normal steering while driving. In this manner, one single device solves the main disadvantages found in current telephone holders available on the market.

### DETAILED DESCRIPTION OF THE INVENTION

The current state of the technology for smartphone stands presents a series of disadvantages, in the operation of the telephone, the firmness with which it is held, and the placement position. The first issue is that operating the telephone requires releasing at least one hand from the steering wheel. This goes against the ideal of always having both hands at the wheel. On the other hand, the existing devices don't hold the telephone steadily. This causes the telephone to move around when the user tries to hit buttons that require a certain degree of pressure, preventing successful activation of desired commands (21). Another factor to consider is that some existing devices touch the compartment that stores the air bag at the center of the steering wheel. The placement of yet other devices (in front of the steering wheel) obstructs road visibility and the free maneuver of the steering wheel because the hands run into it while driving. All these issues are solved with the device described below:

The handsfree smartphone stand for mounting behind the steering wheel (19) consists of the following elements:
1. At least one strap (1) that attaches to the steering wheel with three elements of design: First, the surface that supports the device on the steering wheel (1.b.1). Second, at least a screw (3) that allows the two pieces that constitute the strap (7 & 8) to put pressure against the steering wheel. The third is a rubber surface that creates grip on the strap.
2. The strap mentioned above has two pieces (top (8) and bottom (7)) which come together with an opening (24) and an edge (6) with frontal alignment in one end and the screw (3) in the other. Both pieces have holes to allow for alignment. The strap is wider in the front, with measurements in the range of 2.5 cm to 4.5 cm and narrower in the back, with measurements in the range of 1.5 and 3.5 cm. Both pieces come apart to be placed on the steering wheel (Drawing 5). The rubber surface (9) has a thickness in the range of 1 mm and 8 mm.
3. A supporting box (2) for the telephone with a width in the range of 1.5 cm and 5 cm, and a height in the range of 4.5 cm and 7 cm. This has two covers: the back cover (18) that screws to the strap (referred to on 1) with a screw (3); and the front cover (17) which comes together with the back cover sliding into tracks (16) and at least one pin on top (10). The tracks and pin allow the covers to extend and contract to adjust to the different sizes of telephones.
4. The back cover of the supporting box, described in point 3, attaches to the strap by means of a triangular shape on top (14). This surface consists of a base between 1.4 cm to 2.7 cm, and a height between 0 cm and 2.5 cm and serves as a base of support for the strap. It uses a screw to secure in place. The dimensions of this triangular surface, create angles in the range of 10 and 35 degrees, shown in 6.22 and 6.23. These angles allow to hold the telephone horizontally in the space behind the steering wheel.
5. Each of the covers described in point 3 has a fastener (4 & 5) on one end. These fasteners hold the telephone by its sides and have a width between 0.9 cm and 1.2 cm and a length of 4.5 cm and 5.5 cm. They overlap the width of the box with a range of 0.5 cm to 1.5 cm to widen the base for the telephone (15). Since the telephone is meant to be placed horizontally, the fasteners don't allow up-down movement. The fasteners contain two elements that prevent the telephone from springing forward towards the driver:
   A 1 mm inner vacuum covered with rubber pieces (11) which besides protecting the telephone, firmly grip it in place reducing its movements (21). These rubber pieces are between 2 mm and 5 mm wide.
   An edge that holds the telephone on the device (13) between 2 mm to 5 mm tall. The rubber pieces (11) have an inner track (12) with a depth between 1 mm and 2 mm, which prevents the fasteners (4 & 5) from interfering with the lateral buttons of some telephones. With this feature, the user can move the telephone from one side to the other of the fastener; adjusting for visibility of the dashboard and lefthanded operation.
6. The covers of the box described in point 3 are held together with the fasteners described in point 4 and with a pressure mechanism consisting of: (a) tracks (16), (b) at least one pin on top (10), and (c) front and back covers as stated in claim 4.

When installing the stand on the steering wheel, the acute angles with which the strap attaches to the box as shown in Drawing 6 (22 & 23), allow placing the telephone behind the steering wheel (19).

These mechanisms to hold the telephone offer certain advantages over the devices currently available:
1. Telephone operation while keeping both hands on the steering wheel.
2. Telephone is held firmly avoiding unwanted movements which might interfere with pressing buttons.
3. Neither the stand nor the telephone touch the central section of the steering wheel where the airbag (28) and the horn are located; nor interfere with the operation of the lights, turn signals and windshield levers, which don't turn with the steering wheel and are joined to the main steering wheel column (27).
4. Neither the stand nor the telephone is an obstacle for the important function of steering and, because of their placement, don't hit the driver's legs when doing a 180° spin.

### Possible Variations on the Stand:

1. The manufacturing material can be metal, plastic and/or carbon fiber among others.
2. The surface attached to the steering column and that supports the strap can have different dimensions.
3. The dimensions of the supporting box on which the telephone is placed, can vary and it can be placed either horizontally or vertically to adjust to the size of the telephone.
4. The fasteners that hold the telephone's sides can also have different dimensions.
5. The appearance of the strap and the box can be modified to adjust to different customer's tastes.
6. The mechanisms that attach the strap to the steering wheel can have different designs; such as: eliminating the screw and replacing it with a manually adjustable lock mechanism.
7. The strap and stand can be designed in one piece, avoiding the need of a screw.
8. Default angle of placement of the strap and fastener can be modified; allowing for additional mechanisms that allow the driver to change these angles according to their needs.
9. A power bank/battery can be attached to the rear of the stand.
10. A logo can be added to any of the faces of the stand.

### BRIEF DESCRIPTION OF THE FIGURES

FIG. 1. Lateral (a) and front (b) view of the smartphone held by the device on the steering wheel

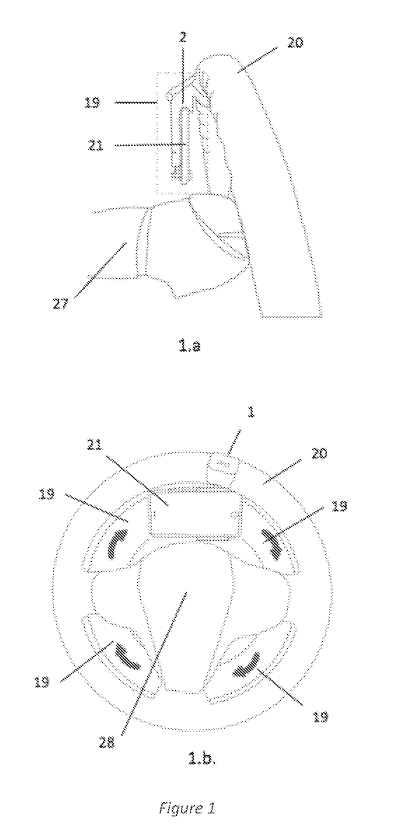

FIG. 2. Frontal view of the stand at a 45° angle

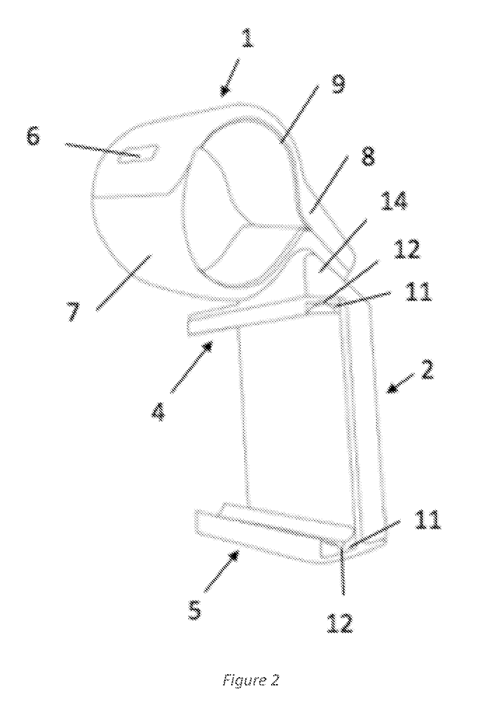

FIG. 3. Rear view of the stand at a 45° angle

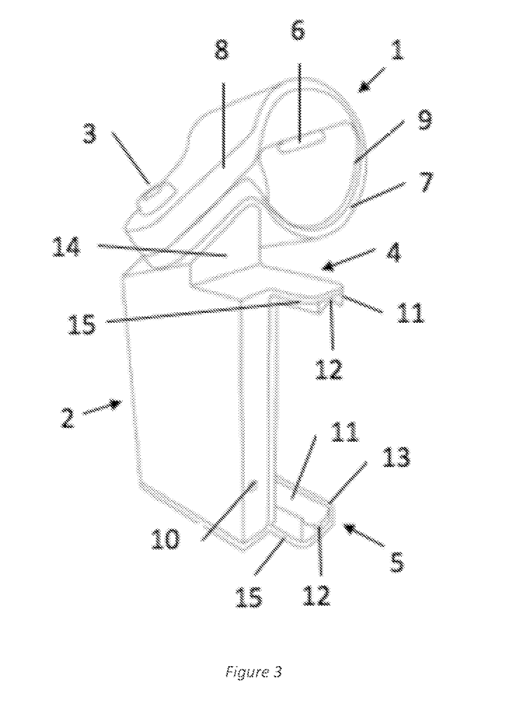

FIG. 4. Lateral view of the device with extended pressure mechanism

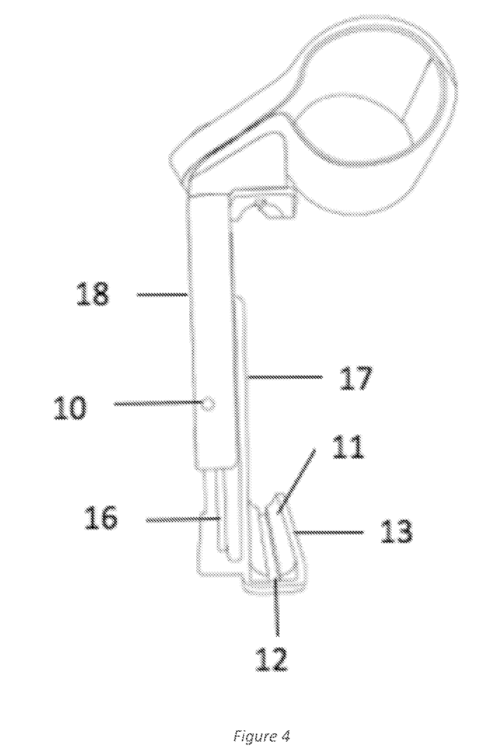

FIG. 5. Sections of the metal strap (front view)

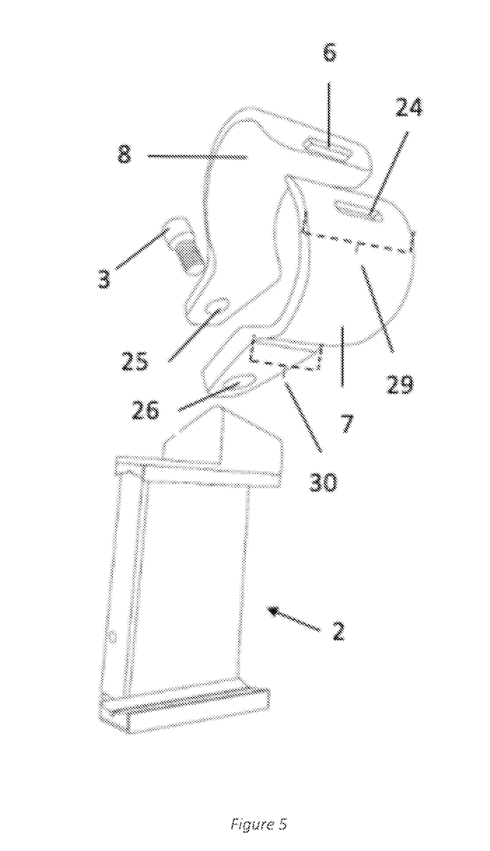

FIG. 6. Rear view of the stand showing the angles

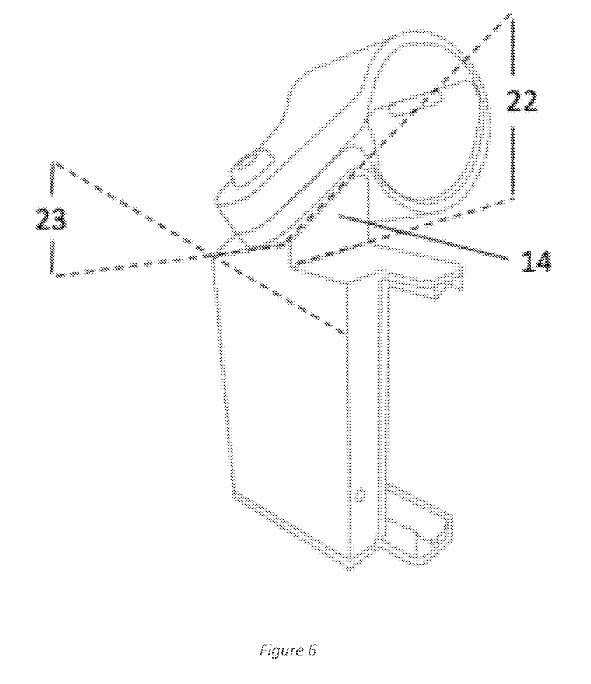

### LIST OF IMAGES

1. Strap that attaches to the steering wheel
2. Supporting box on which the telephone is placed
3. Screw that puts pressure on the strap and the supporting box
4. Top fastener
5. Bottom fastener
6. Alignment edge
7. Bottom portion of the strap
8. Top portion of the strap
9. Interior rubber sheathing of the strap
10. Closing pin
11. Rubber bases to secure the telephone
12. Track that prevents interference with buttons
13. Edge that prevents the telephone from falling off
14. Surface that protrudes from the box that supports the strap
15. Portion of fasteners that extend from the metallic box
16. Guiding tracks of the opening mechanism
17. Front cover of the supporting box
18. Back cover of the supporting box
19. Space behind the steering wheel where the stand places the telephone
20. Steering wheel
21. Smartphone
22. Lateral angle of the surface that protrudes from the box and is the base for the strap
23. Rear angle of the surface that protrudes from the box and is the base for the strap
24. Front slot used to align the strap
25. Top strap opening that takes the screw
26. Bottom strap opening that takes the screen
27. Steering wheel column
28. Airbag compartment in the steering wheel
29. Wider portion of the strap
30. Narrower portion of the strap

1. A stand to hold smartphones on the car's steering wheel which includes: at least a strap (1) placed on the steering, at least a screw (3) that closes the strap together and attaches it to the supporting box (2); allowing to hold the telephone horizontally through a pressure mechanism in the space behind the car's steering wheel (19). The stand can be manufactured using metal, plastic, carbon fiber and can have a telephone charging battery.

2. The handsfree smartphone stand for mounting on the steering wheel according to claim 1, in which the strap that goes around the steering measures between 2.5 cm and 4.5 cm at its widest front part (29), and between 1.5 cm and 3.5 cm in its rear narrower portion (30). This strap has a rubber sheathing (9) with a thickness that ranges between 1 mm and 8 mm.

3. The handsfree smartphone stand for mounting on the steering wheel according to claims 1 and 2, featuring a strap (1) that has: (a) a top piece (8) and (b) a bottom piece (7) which mirrors the other (Drawing 5). Both pieces come together through a: (a) a slot (24) and the front alignment edge in one of the ends (6) and the screw (3)—referred to in claim 1—which joins the two portions of the strap through the openings (24 & 25), aligning them and securing them to the supporting box.

4. The handsfree smartphone stand on the steering wheel according to claims 1 and 2 that has a supporting box (2) with a width between 1.5 cm and 5 cm and a height in the range of 4.5 cm and 7 cm, has two covers: (a) the back cover (18) which attaches to the strap by means of the screw (3) according to claims 1 & 2; and (b) the front cover (17) that attaches to the back cover with the tracks (16) and a closing pin (10) which secures them together.

5. The handsfree smartphone stand for mounting on the steering wheel according to claims 1 and 2 in which the back cover (18) of the supporting box (2), according to claim 4, is attached to the strap through a triangular surface on top (14). This surface is between 1.4 cm and 2.7 cm wide and between 0 cm and 2.5 cm high and serves as a base for placing the strap and screwing it securely. The triangular surface (14) forms angles ranging between 10 to 35 degrees (shown on drawing 6.22 and 6.23) which allow for horizontal placement of the telephone behind the steering wheel (19).

6. The handsfree smartphone stand for mounting on the steering wheel according to claims 1 and 4, with a supporting box that has fasteners on both the front and back covers. These fasteners have a width between 0.9 cm and 1.2 cm and a length from 4.5 cm to 5.5 cm (4 & 5); and have the following components: a) An inner vacuum of at least 1 mm of depth on which rubber strips are placed (11) with a thickness between 2 mm to 5 mm. These rubber strips have inner tracks (12) from 1 mm to 2 mm deep. b) An edge, between 2 mm to 5 mm high, which holds the telephone in place in the device (13).

7. The handsfree smartphone stand for mounting on the steering wheel according to claim 1 and the fasteners that go at the ends of the covers according to claims 4 & 6, protrude the width of the supporting box (2) in a range between 0.5 cm and 1.5 cm (15) with the goal of increasing the gripping surface.

8. The handsfree smartphone stand for mounting on the steering wheel according to claims 1 and 4, in which the front and back covers are held together by means of a pressure mechanism composed of: a. tracks (16), b. at least a closing pin (10), and c. the front and back covers per claim 4.

9. The handsfree smartphone stand for mounting on the steering wheel according to claim 1, in which the strap (1) and supporting box (2) can be one single piece, eliminating the screw (3).
